(19) United States
(12) Patent Application Publication
(10) Pub. No.: US 2011/0161338 A1
(43) Pub. Date: Jun. 30, 2011

(54) DYNAMIC TASKING-MASKING SERVER APPARATUS, SYSTEM, AND METHOD FOR DYNAMICALLY CONFIGURING ADAPTIVE AGENTS IN WIRELESS DEVICES

(75) Inventor: DUSTIN MICHAEL MOORE, SAN JOSE, CA (US)

(73) Assignee: CARRIER IQ, INC, Mountain View, CA (US)

(21) Appl. No.: 13/043,347

(22) Filed: Mar. 8, 2011

Related U.S. Application Data
(63) Continuation-in-part of application No. 12/686,394, filed on Jan. 13, 2010.
(60) Provisional application No. 61/289,304, filed on Dec. 22, 2009.

(51) Int. Cl. G06F 17/30

(52) U.S. Cl. 707/758; 707/E17.014

(57) ABSTRACT

A method for operating a dynamic tasking-masking server comprising a circuit to receive a package of metrics recorded at an adaptive server, coupled to a circuit to search an event register for package elements, coupled to a circuit to generate a replacement profile for transmission to the agent, wherein a circuit is comprises a processor adapted by a program product and storage for data and for instructions to adapt the processor accordingly. An apparatus which either masks or unmasks operations defined in a profile on an adaptive agent or provides a replacement profile to the adaptive agent based on configuration-state recorded and transmitted by a package defined in the last profile and comparison with persistent queries stored in an event register data structure.

### RELATED APPLICATIONS

This is a continuation in part of application Ser. No. 12/686394 filed 13 Jan. 2010. Priority is claimed for this application from 22-Dec.-2009 the filing date of provisional application 61289304 attorney docket Q-PTNTR200925 Confirmation Number 7866 which is incorporated by reference in its entirety.

### BACKGROUND

A passive collection server, at a uniform resource identifier(URI) is known in the art, which operates a secure hyper text transfer protocol (https) service. Any agent may initiate an https post transfer to this URI. The passive collection server attempts to accept every transfer, unconditionally. If successful, the passive collection server stores and acknowledges the transfer. If unsuccessful, the agent, an https client, will automatically retry. Thus, it is impossible for the server to prevent the transfer.

Today, data which is stale, or duplicative, or no longer of interest consumes bandwidth. A study which initiated data acquisition may have ended or based on initial results have been substantially evolved. Sufficient samples may already have been acquired of the mean, median, and mode of the distribution. Large volumes of obsolete data occupy storage. Furthermore, costly analysis cycles are consumed to determine that the data is no longer of use and to determine that it can be discarded.

In addition to hiding desirable data in a thicket of useless data by the mere fact of its volume, the volume of data being uploaded may resemble a self-inflicted denial of service attack. The receiving server at the destination uniform resource identifier may sometimes be too busy during peak upload periods to receive a rare but desirable upload.

A prior art tasking server receives identification information from each agent and distributes profiles to agents generally according to their identity. An external selection process has selected agents to potentially participate in a study. Current information provided by the agent may disqualify it from receiving a profile but does not today determine the profile the agent should receive.

The process of developing a prior art profile is deterministic and done in anticipation of a certain scenario. Only a fixed number of profiles is available in practicality due to the development, test, and debugging effort. In any case the tasking server is capacity constrained to a fixed number of available profiles to manage.

Economically, it can be expensive to contact each and every agent of a large population. Therefore, because it is expensive to modify a profile on demand, each profile has a longevity determined by the reporting period previously encoded into the most recently distributed previous profile. For example, if a set of agents had received a profile to report their packages of data every 2 months, then the mean time to replace that profile would be one month after the decision to do so.

Even if an agent transmits a package containing an event of interest, there might be little that can be learned from it. Only the data that was anticipated to be of interest is recorded. It may be essentially the same report of a problem from many agents without more details to analyze. It can be observed that a problem is widespread and common but otherwise the data may be thin, duplicative, and obsolete by the time it is recognized.

Prior art, as disclosed in a related U.S. Pat. No. 7,609,650 issued Oct. 27, 2009, provides for a service quality platform of a data collection and management system to download to a population of wireless devices static data collection profiles. Profiles identify information which is to be recorded on the devices in response to specified conditions and events, as well as the conditions and events that enable the device to upload the set of recorded information. Conditions or events include selected occurrences in the network or on the device that the device can sense, such as a call dropping or a user pressing a button on the device. Conditions and events also include the passage of time, or a request from a network administrator that the device report to the server.

However, the number of studies that can be developed and conducted concurrently is constrained by the manner in which a profile can be created, the devices selected, the profiles transmitted, and data received. Accordingly, response to a transient problem may be delayed.

It can be appreciated that what is needed is a solution which acquires data from a plurality of agent-configured apparatuses but in which less data is transferred. Less storage of unneeded, stale, or duplicative data would be advantageous over present solutions. Furthermore, what is needed is finer grained measurements tailored to each situation. Measurements should not be limited to anticipated scenarios or confirmation of hypotheses. Assignment of tasks to agents should reflect the latest understanding of interesting problems. New scopes of research or areas of study should be converted to profiles and distributed on a continuous rather than batch schedule.

An economical system for collecting measurements from among a large plurality of wireless stations by what is effectively self-selection towards a plurality of concurrent studies which avoids network congestion, data duplication, and impertinent submissions would address the limitations of conventional systems, methods, and apparatus described above.

| Term | Definition |
|---|---|
| Service | A definition of entities and the relationship among |
| intelligence | entities for a particular domain e.g. EVDO push to |
| module | talk or GSM/UMTS data transactions. Event models |
| | are described within each domain and the derivation of |
| | each event from metrics. The outputs are the key |
| | performance indicators and useful aggregations |
| | appropriate for a particular domain. Dependency |
| | analysis determines which inputs are necessary to |
| | produce each available aggregation or key performance |
| | indicator defined with a Service Intelligence Module |
| | (SIM) |
| Configuration- | Measured values or recorded behaviors that a device can |
| state | stream and store based on its instrumentation of the |
| | environment, user-behaviors, internal status, and history. |
| | A non-limiting exemplary configuration-state may be a |
| | range of values, a member of a list, a set of name- |
| | condition pairs. a range of coordinates, a range of time |
| | or dates, an average rate within a period, a percentage |
| | of success over attempts, a calendar start and end, |
| | a time start and end, and status bits of the hardware or |
| | software. |
| envelope | A set of configuration-state values which are of interest |
| | to at least one study and within which it is desired |
| | that an agent record performance and user behaviors |
| | according to a profile. |
| Tasking | A set of configuration-state values and at least one of: |
| specification | Relative priority |
| | Latency from event to upload |
| | How much data is desired |

### BRIEF DESCRIPTION OF FIGURES

FIG. 1-4 are flow chart diagrams of the method embodiment of the invention for operating a server comprising a processor.

FIG. 5 is a block diagram of the apparatus embodiment of the invention as a server coupled to an event register store and to a plurality of adaptive agents.

FIG. 6 is a dataflow diagram of an exemplary system employing a tasking-masking server.

FIG. 7 is a block diagram of a server executing the method embodiments.

### SUMMARY OF THE INVENTION

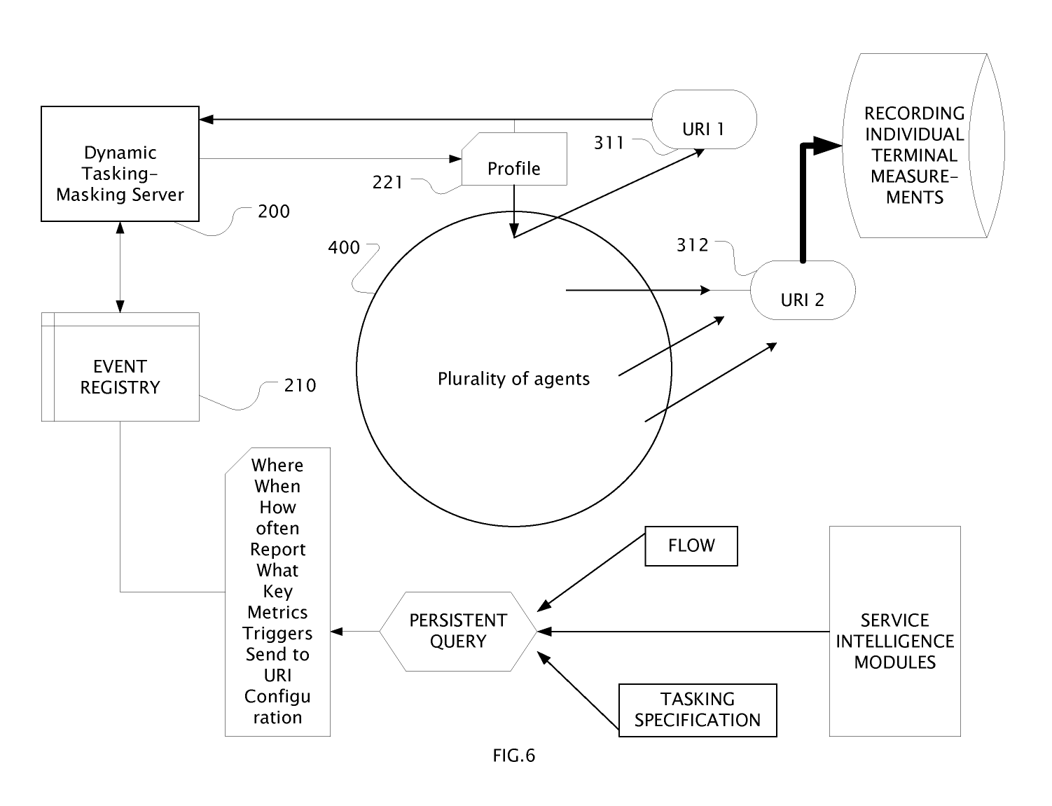

Referring to FIG. 6, the present invention comprises a dynamic tasking-masking server 200 which is a component of a system comprising a plurality of adaptive agents 400, and at least one discriminating collection server 311, 312. Each one of these separately may be implemented and deployed to work with prior art elements advantageously. However, operating together would be one embodiment. A plurality of adaptive agents may be mixed with a plurality of conventional agents without harm. Adaptive agents may be configured to operate in the conventional way: subscribing to and recording data streams according to a profile, transmitting packages of data according to a profile and checking for a replacement profile in compatibility with a conventional collection server and a conventional tasking server. Similarly a discriminating collection server may be operable by providing selectable control between unconditional acceptance and discriminating acceptance. For conventional agents, the discriminating collection server will unconditionally accept an hyper text transfer protocol (http) post transaction. In like manner a dynamic tasking-masking server may mix identity-based tasking with dynamic tasking-masking. If a conventional agent transmits only identity credentials, the dynamic tasking-masking server can still provide a suitable profile.

One aspect of the present invention is tasking-masking a plurality of adaptive agents which augment the functionality of conventional agents by additionally subscribing to more, fewer, or different data feed streams. This can be done by adding thresholds, computations, and logic into a replacement profile which adapt the agent to examine and operate on recorded data or by changing the mask of a last profile. For example two completely orthogonal and incompatible events might occur which are mutually exclusive. And the data necessary to analyze one has no overlap with the data to analyze the other. It is wasteful to record the superset of data for both events because at least one and possibly both subsets would be eventually discarded as uninteresting. By adapting the data feed stream according to the detection of one event or the other, more capacity is obtained for storage.

Another aspect of the present invention is tasking-masking a plurality of adaptive agents which augment the functionality of conventional agents by additionally modifying a destination uniform resource identifier. In one embodiment, the destination may be determined by a regular expression controlling a subdirectory of the collection server. In another embodiment, the destination uniform resource identifier may be selected according to a preliminary analysis of the recorded data or user behavior.

Another aspect of the present invention is tasking-masking a plurality of adaptive agents which augment the functionality of conventional agents by additionally extending or shortening their reporting period. For example, an event may be determined from analyzing recorded data or user behavior that initiates an immediate report to the collection server. This can be accomplished by setting a timer to zero. Or extending the reporting period may be desirable upon examining the battery charge, signal strength, and user activity.

Another aspect of the present invention is tasking-masking a plurality of adaptive agents which augment the functionality of conventional agents by additionally operating on recorded data to summarize and type the package. Metadata about the package may be submitted to a discriminating collection server as part of a proposed upload. By operating on the recorded data, the agent may determine if the package represents a corner case in a study or is likely to be duplicative of the most commonly reported cases. In an embodiment the agent may compare metadata about the package with metadata about previously collected packages.

It is understood among those skilled in the art that the tasking-masking server may not be a separate physical server and may not only share hardware resources but also share software with a collection server. It is described separately solely for clarity of understanding as separably inventive.

One aspect of the present invention is a dynamic tasking-masking server which augments the functionality of a conventional tasking server by reading, in addition to the identity of the agent, configuration-state data from the package of the last reporting period.

The package of the last reporting period may show some recent changes in the configuration of the agent. Examples of changes in the configuration might be the location, the software release, the radio signal statistics. Other changes might be in user behaviors recorded. Other changes might be in quality or reliability measures. Alternatively, the configuration state may be in the normal range and show little variation from previous values or expected values for that make/model/user.

A further aspect of a dynamic tasking method is determining when a profile should be replaced or not replaced, based on configuration-state data. The dynamic tasking server may determine that an agent's configuration-state corresponds to a new study just released. The dynamic tasking server may determine that an agent's configuration state reflects a degradation or impending failure. The dynamic tasking server may determine that an agent's configuration state indicates a special environment or configuration which requires more detailed measurements to diagnose. Or the dynamic tasking server may determine that the same profile should be continued without change or that portions of the profile should be masked or unmasked to enable or disable subscription, recordation, or transmission of data.

A further aspect of a dynamic tasking-masking method is compiling and transmitting a replacement profile according to an event registry store. An event registry store is disclosed in the detailed specification which has all the dimensions of configuration state which can be measured, recorded, or reported by an agent. All studies are represented in the event registry store and specify the user behaviors, data streams, destination uniform resource identifiers, upload schedules, and packages that should be incorporated into a replacement profile.

The present invention is a component of a system, apparatus and method for asking a persistent query of a system of wireless communications. One aspect of the invention is tasking-masking qualified agents which are installed in a variety of mobile communication devices. Qualifications may be selected from specific categories of hardware, software, state, and configuration. The agents in one embodiment may self-select or in another embodiment may report their current configuration state and be selected by a dynamic tasking-masking server. If selected for a plurality of studies, the agent receives at least one profile. In an embodiment, if an agent is selected for two or more studies in which the information is required to be uploaded to two or more distinct Mobile Service Intelligence Platforms (MSIP) instances, the agent receives a plurality of profiles.

Each profile determines which device characteristics are useful to measure performance and how often and what conditions should be stored. The profile may further determine that interactions between the user and software applications are monitored and, under certain conditions, record user behavior. Configuration-state includes the radio conditions, hardware status, recent error rates, and user behaviors. A single profile, in one embodiment, prepares more than one type of package. In another embodiment, a single profile prepares one type of package with variable destination uniform resource identifier. Multiple profiles are appropriate for studies that are being conducted for unrelated clients to avoid confidentiality issues. To avoid wasteful transfer and storage, the collecting method may refuse to accept data for a variety of reasons. The data may be stale, the study not open, or a statistically sufficient number of reports may already have been accumulated to answer the query.

The present invention is a system, method, and apparatus for dynamically tasking-masking a plurality of agents to measure performance and record user behavior in a wireless network. It is understood that the various servers described are logical systems which may be combined in operation on fewer physical servers or scaled to be distributed among multiple physical servers organized as a grid which provide the functionality. It is for the ease of conveying the concept of the invention that functionality is described herein as related to recordation or analysis or application. From time to time individual members of the grid will participate in recordation, in analysis and in application methods. A domain specific body of knowledge referred to as a Service Intelligence Module may be applied to data both at the analysis server in batch processing and/or at the application server in interactive manipulation and display of data.

An event registry store contains the conditions and requirements of all active persistent queries. Each persistent query comprises a flow and a tasking specification. The flow describes the desired output to be collected and analyzed for a selected domain and applies to at least one service intelligence module. The tasking specification describes the configuration-state of agents which qualify for a study and at least one of the following: how much data is to be collected, the latency of reporting events, and the priority of the tasking specification relative to other tasking specifications. The result of compiling the flow, its tasking specification, and related service intelligence modules populates the event registry for one Persistent Query. When an agent, in one embodiment, reports configuration-state data in a package, the tasking-masking server determines if a replacement profile should be generated by examining all the Persistent Queries active in the event registry and compiling a replacement profile if appropriate for that agent.

It is understood that a replacement profile may be cached and served to a second agent reporting substantially the same configuration-state data. It is understood that the tradeoff between pre-computing most likely requested profiles and dynamically determining a profile may be optimized by those skilled in the art.

### DETAILED DISCLOSURE OF EMBODIMENTS OF THE INVENTION

The present invention concerns conducting several studies by concurrently recording and collecting measurements. Each measurable parameter is part of the configuration-state.

A study definition calls upon a selection of service intelligence modules which contain a collection of data displays, transformations, and measurements. Depending on the study not all displays and measurements that can be operated on by a service intelligence module need be collected. A profile is assembled from the requirements of the service intelligence modules with respect to the study definition which specifies the frequency of measurement and which device parameters and user behaviors are to be recorded.

Each study determines the qualification of the agents which shall potentially receive the profile. In an embodiment, the agents self-select to receive each profile. In an embodiment, the agents are selected but receive each profile on their own initiative. In an embodiment, certain agents are directed to receive a second profile by matching qualifying conditions of configuration-state in a first profile.

Agents may be permanently embedded in a mobile device or removably embedded in a wireless modem datacard which can be shared among mobile devices. Generally agents have a hardware and software configuration which while updatable is not extremely dynamic. In contrast, being assigned to mobile devices, the location is very dynamic and an agent may pass through many envelopes. In an embodiment, an agent may also be installed as an after-market application or system service on a device that allows such things (inter alia, a smartphone).

Tasking a profile to an agent may depend on the agent's recent history in transient events, in radio signal strength, in bit error rates, in bad cellular areas, in internal state or statistics in the radio channel. Tasking a profile to an agent may depend on its location near to other agents having a recent history in transient events, statistics in the radio channel, bad cellular areas, and radio signal strength as a control.

The dynamic tasking-masking server receives a most recently reported package from an adaptive agent, examines an event registry, and, if appropriate, offers a replacement profile to each agent.

Applicants disclose an apparatus and a method for operating the apparatus which is attached to a storage device providing a searchable event register data structure. The apparatus is further communicatively coupled to a plurality of adaptive agents which receive profiles, record data, determine measurements, and transmit packages of the measurements according to their received profiles.

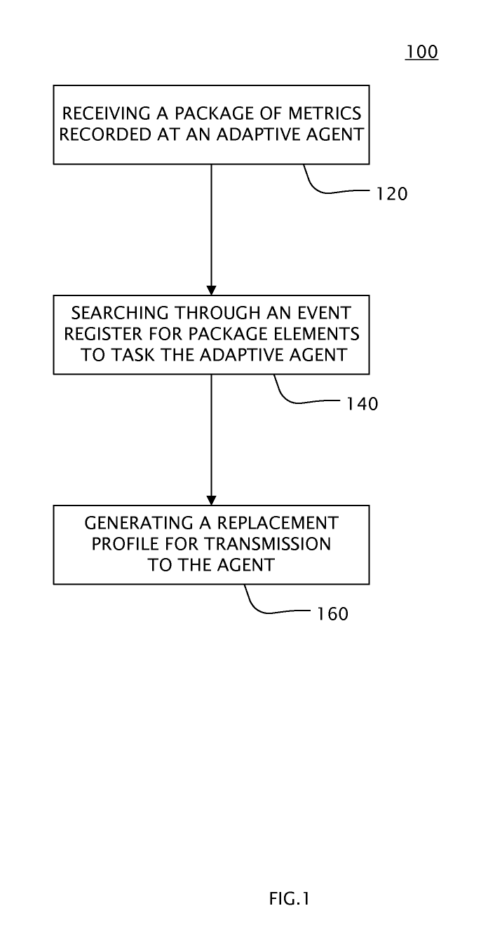

Referring now to FIG. 1, the present patent application discloses a method for operating a dynamic tasking-masking server comprising a circuit to receive a package of metrics recorded at an adaptive server, coupled to a circuit to search an event register for package elements, coupled to a circuit to generate a replacement profile for transmission to the agent, the method steps 100 include:

receiving a package of metrics 120 recorded at an adaptive agent, wherein receiving comprises determining whether a profile on the adaptive agent should be replaced;

searching through an event register data structure in an event register store 140 for package elements to task the adaptive agent; and

generating a replacement multiple package profile 160 for transmission to said adaptive agent, the circuits implemented as a processor configured by a program product and storage for data and for instructions to adapt the processor accordingly.

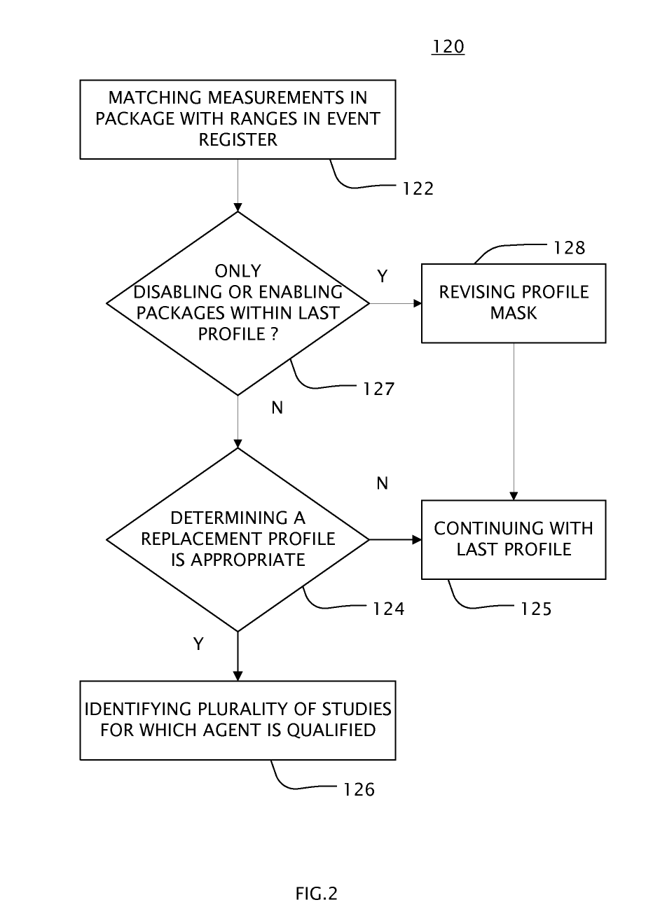

Referring now to FIG. 2, the method of receiving a package of metrics 120 includes:

matching measurements received in a package of metrics with ranges stored in an event register data structure in an event registry store 122,

identifying a plurality of studies for which an agent is qualified 126 if it is determined that a replacement profile is appropriate 124 because at least one measurement received in a package of metrics is within a range and the studies the agent qualifies for is different that the studies in the previous profile; and

continuing with a last profile 125 if it is determined that a replacement profile is not appropriate.

In an embodiment, the method of receiving a package of metrics also includes the step of determining if packages defined within the last profile may be disabled 127. It may be that a sufficient number of samples of a certain package have been acquired to meet the study need. It may be that all the packages of a particular study are no longer needed. Rather than retransmitting a profile simply to delete a portion, the recording and transmission of data only required for those portions may be suppressed by changing a mask. It may be that the profile already contains definitions for packages and studies that are not presently active. The enablement of recording and transmission of data defined in a portion of a profile already downloaded may be controlled by revising a profile mask 128.

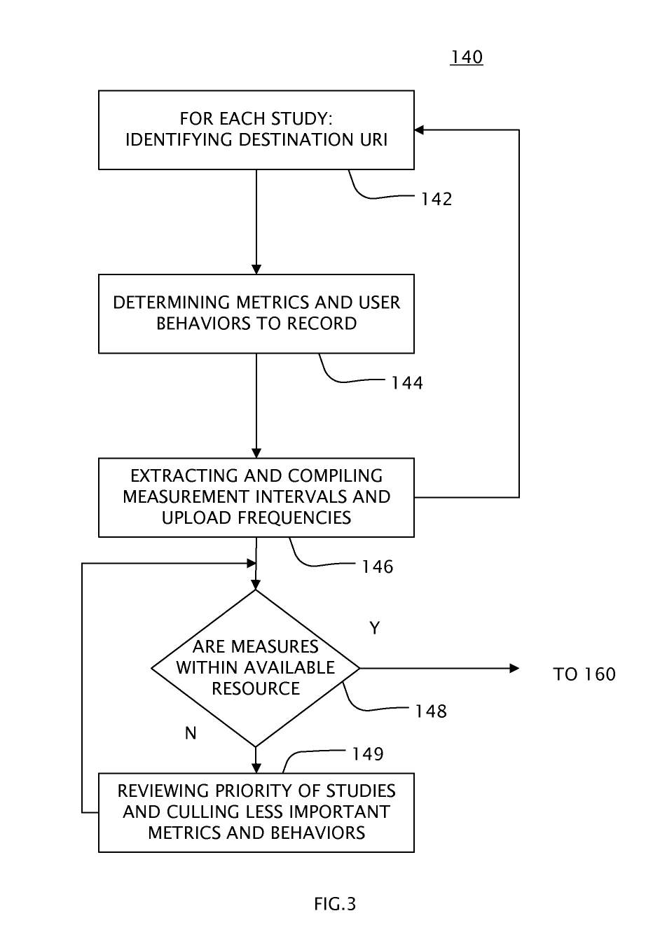

Referring now to FIG. 3, the method of searching through an event register data structure in an event registry store 140 includes the following steps:

for each one of a plurality of studies for which an agent is qualified, identifying a destination uniform resource identifier (uri) 142,

determining which metrics and user behaviors to record 144 to accomplish each one of a plurality of studies, and

extracting and compiling measurement intervals and upload frequencies for each one of a plurality of studies 146.

In an embodiment the method has the additional steps:

reviewing the relative priority of each one of a plurality of studies 149 and

culling out at least one less important metric and behavior, if the measures are not within available resources in an agent 148, and

transferring control to profile generation 160 when the measures are within available resources.

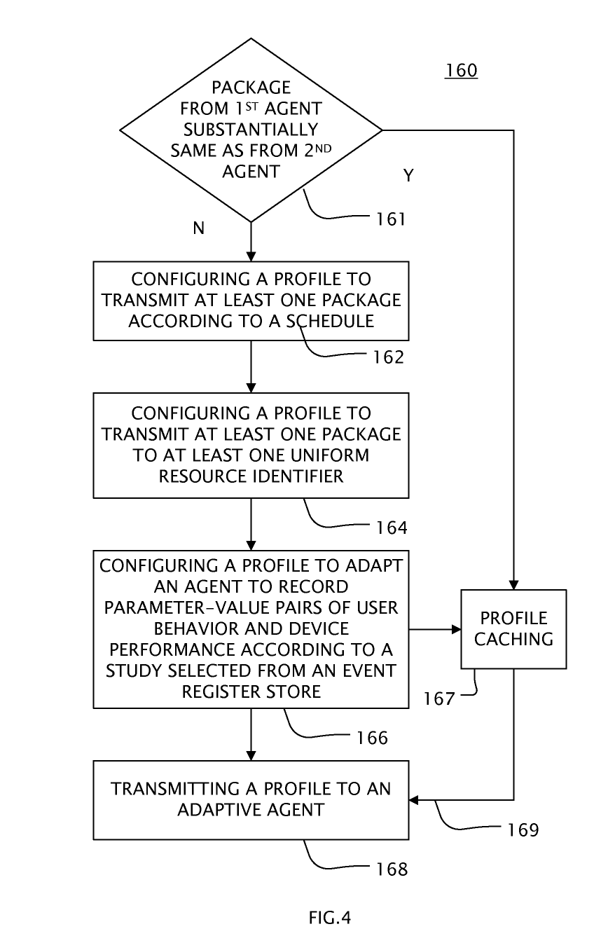

Referring now to FIG. 4, in an embodiment, the method of generating a replacement multiple package profile 160 includes the following step:

configuring a profile to adapt an agent to transmit at least one package according to a first schedule 162 and at least one package according to at least one second schedule.

In an embodiment generating a replacement multiple package profile includes:

configuring a profile to adapt an agent to transmit a first package to at least one first uniform resource identifier 164 and at least one second package to at least one second uniform resource identifier.

In an embodiment generating a replacement multiple package profile includes the step:

configuring a profile to adapt an agent to record parameter-value pairs of user behavior and device performance according to a study selected from an event register data structure in an event register store 166.

In an embodiment generating a replacement multiple package profile includes the following steps:

transmitting a first profile to a first adaptive agent 168 and storing the first profile into a profile cache 167, and

determining if a package from a first adaptive agent is substantially the same as a package from at least one second adaptive agent 161 and sending the first profile from profile cache to the at least one second adaptive agent 168.

In an embodiment generating a replacement multiple package profile includes:

configuring a profile to adapt an agent to operate on selected parameter-value pairs which result in a first package and trigger a rule-based evaluation of the parameter-value pairs of said first package which configures the profile to further select parameter-value pairs which result in at least one of a plurality of second packages.

A non-limiting exemplary rule-base includes inter alia: truth tables, a sequence of states in a state machine, a collection of if-then tests on conditions or ranges of values, evaluations of mathematical expressions, equalities, or inequalities, expiration of time limits, logic equations, priorities of overriding rules, lists, a list of packages to enable or disable received from a tasking-masking server, a list of studies to enable or disable received from a tasking-masking server, and combinations of the above.

In an embodiment determining whether a profile on the adaptive agent should be replaced or masked consists of:

checking if the profile is older that the latest version of the event register;

matching measurements received in a package of metrics with a profile stored in profile cache, and

generating a replacement profile only if there are new studies in the event register not considered when the profile on the adaptive agent was generated and if a substantially same replacement profile is not already in profile cache.

In an embodiment determining whether a profile on the adaptive agent should be replaced or masked is done by:

checking if a study has been completed;

checking if additional instances of a particular package type are no longer desired, and

generating a mask which enables or disables specific studies or specific packages in a profile and transmitting the mask to the agent.

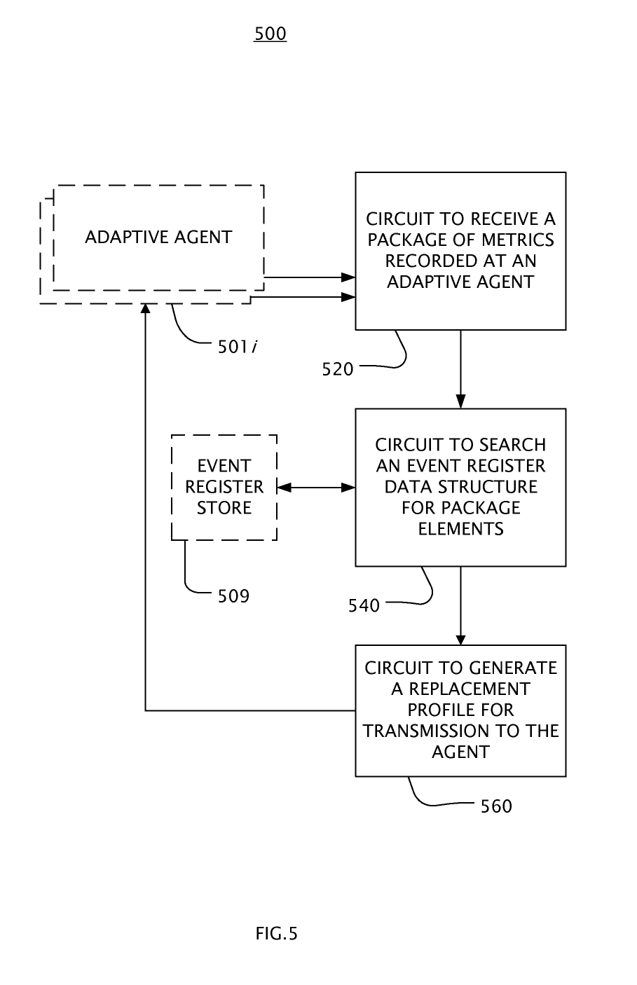

Referring now to FIG. 5, in an embodiment, the invention comprises an apparatus which has at least 3 operative interconnected circuits:

a circuit to receive a package of metrics 520 recorded at one of a plurality of adaptive agents 501i where i is an integer 1 through N wherein N is the number of adaptive agents, coupled to

a circuit 540 to search an event register store 509 for package elements, coupled to

a circuit to generate a replacement multiple package profile 560 for transmission to the agent 501i, wherein a circuit comprises a processor adapted by a program product and storage for data and for instructions to adapt the processor accordingly.

In an embodiment, a replacement multiple package profile which is tangibly encoded on non-transitory computer readable media, is made of executable program instructions in binary code, in interpretive code, in procedural code, or in 4th generation language to manipulate data and measurements at a processor controlled by the adaptive agent. The executable instruction may configure the processor to provide some of the following functionality compress data into packages, summarize a series of events or behaviors, recognize a pattern, monitor a state machine, trigger an upload, change a destination uniform resource identifier, initiate a new package, change a package definition, mask or unmask portions of a profile to enable or disable subscribing to a datastream, enable or disable recording of measurements or behaviors, maintain a rolling history of observations, events, records, send notifications of an event, compute or trace.

A profile may be triggered to initiate measurements by sensing some threshold value or transient condition. A profile may be triggered by the condition of being in a bad cell area, by an internal status bit being set, by a certain frame error rate being passed, or by a record of crash recovery. A profile may be selected to operate or to be installed in a device within a configuration having certain measurements, internal status bits, transient event history, as well as location and calendar. A profile may cause the processor to prepare one or more packages for upload. Multiple profiles may coexist in one agent. A profile may adapt to different circumstances and accordingly record different performance measurement and user behaviors depending on said circumstances. A profile may determine that another profile is appropriate. A profile may trigger certain measurements and evaluations based on prior other measurements and conditions.

A profile includes a schedule or trigger for upload, a fallback for upload failure, a destination URI and a plurality of measures to assemble into at least one package. In an embodiment the profile contains program code to perform computations or thresholds to determine if an upload is enabled or disabled. Program code within a profile may alter the measurements or sense a sequence of events which trigger a specialized set of measurements. The program code within a profile may determine the appropriate measurement for a condition or state.

In an embodiment the replacement multiple package profile generated by the apparatus is made up of:

at least one first package definition with a first uniform resource identifier (uri) destination and

at least one second package definition with a second uri destination wherein the first uri is not equal to the second uri.

In an embodiment the replacement multiple package profile has

at least a first package definition comprising a first set of parameter-value pairs and

at least one second package definition comprising a second set of parameter-value pairs wherein the first set of parameter-value pairs of the first package is not equal to the parameter-value pairs of the at least one second set.

In an embodiment the replacement multiple package profile has both

at least one first package definition comprising an upload schedule and

at least one second package definition comprising a second upload schedule wherein the first upload schedule is different from the second upload schedule.

In an embodiment the replacement multiple package profile includes

at least one first package definition specifying parameter-value pairs and

at least one second package definition specifying parameter-value pairs and

a trigger conditioned by a rule-based evaluation of the parameter-value pairs of said first package which activates recording the parameter-value pairs of the at least one second package.

In an embodiment the replacement multiple package profile has two or more package definition:

at least a first package definition specifying parameter-value pairs and

at least one second package definition and a trigger conditioned by a rule-based evaluation of the parameter-value pairs of said first package which configures said at least one second package definition.

In an embodiment the rule-based evaluation of the parameter-value pairs of said first package configures said at least one second package upload schedule definition.

In an embodiment the rule-based evaluation of the parameter-value pairs of said first package configures said at least one second package profile identification definition.

In an embodiment the rule-based evaluation of the parameter-value pairs of said first package configures said at least one second package destination uri definition.

In an embodiment the rule-based evaluation of the parameter-value pairs of said first package configures said at least one second package parameter-value pairs to record definition.

In an embodiment the rule-based evaluation of the parameter-value pairs of said first package configures said at least one second package definition to select and perform a computation on a plurality of parameter-value pairs.

In an embodiment the circuit to search through an event register data structure for package elements comprises a circuit to

identify the destination uri for each study,

determine a package of metrics and user behaviors to record, and

determine at least one upload schedule.

In an embodiment the invention also has another circuit to reduce the number of packages, metrics, and uploads to be optimized according to relative priority among studies, the relative priority retrieved as a stored parameter in the event register store.

In an embodiment the circuit to receive a package of metrics recorded at an adaptive agent, comprises a circuit to match recorded parameter-value pairs within a range.

In an embodiment the circuit to receive a package of metrics recorded at an adaptive agent, comprises a circuit to match recorded user-behaviors.

In an embodiment the circuit to receive a package of metrics recorded at an adaptive agent identifies a plurality of studies for which the agent is qualified to sample performance metrics.

In an embodiment, the invention comprises an apparatus for dynamically tasking-masking an adaptive agent has at least 4 operative interconnected circuits:

a circuit to receive a package of data recorded at an adaptive agent,

a circuit to match data values in a package with at least one study profile stored in an event registration data structure,

a circuit to determine that a modified or replacement profile is appropriate for said adaptive agent, and

a circuit to modify a profile or download said replacement profile to said adaptive agent.

In an embodiment said study profile stored in a data structure within the event registry store is at least location and time reported by an adaptive agent.

In an embodiment said study profile stored in an event registration data structure is at least error codes and device performance metrics recorded by an adaptive agent.

In an embodiment said study profile stored in an event registration data structure is at least user behaviors and applications recorded by an adaptive agent.

In an embodiment, a dynamic tasking-masking server determines a replacement profile because current configuration-state parameters have substantially changed from previous configuration-state parameters in at least one of physical location, internal state parameters, external environmental conditions, hardware status, software settings, and long interval from previous registration.

In an embodiment, registering with a tasking server includes the steps:
reporting coordinates in time, and
reporting coordinates in space.

### About the Event Registry Store

The event registry store is used in conjunction with the configuration-state data within each agent's most recently reported package to determine when a replacement profile is appropriate. Every persistent query being run on a given Mobile Service Intelligence Platform (MSIP) instance is issued in terms of a set of interesting event types, including both the characteristics of an event that would make it interesting (e.g., it was a call drop that occurred in New York City while talking to one of a small set of cells of interest) as well as specific aspects of the event in which the query is interested (e.g. the call setup latency, the average signal strength, a full record of all handoffs, etc.). In an embodiment, these events and the context surrounding them are registered with a system-wide “event registry”, which is a complete record of all of the events being studied by all active queries on that MSIP instance.

An event registry store contains a set or envelope of locations within configuration-state space including time, space, internal state, and external environment where and when measurements would be pertinent for a study as well a population within the device census of hardware, software, release and configuration which controls which devices may submit measurements.

The event registry store provides an input to a circuit which generates profiles for devices. In a degenerate case, a single profile can be generated for all devices, which includes logic to look for all events of interest. Because the profile definition is very flexible (as cited in other patents), this is feasible for relatively small numbers of events. This simple technique becomes less practical, however, as the number of persistent queries (and thus the number of distinct types of interesting events) grows. This is because the profile itself may grow too large, or the mobile device may be unduly taxed by the effort of looking for events which it has little or no chance of seeing. As the number of events grow, then, there is a more sophisticated technique called for.

Therefore, for large numbers of events, the event registry store is used to build a map of the total device configuration space, including location in space and time as well as conditions regarding various state parameters (e.g. firmware revision, applications present on the device, features that have been used, etc.). This mapping subdivides the space into some number of (potentially overlapping) “configuration envelopes” within which events may occur (or may occur with higher likelihood than in the broader space). A device is then understood to be located within zero or more of these envelopes at any given time.

Armed with this mapping of configuration space, a profile can be generated for a given device in a given state which is customized to look only for events which may occur within those configuration envelopes that contain that device's point in configuration space. In addition, this profile is also programmed to look for “transition events” which signal that the device has changed its envelope containment—either entering a new envelope or leaving one that it was previously in. Upon observing these transition events, the profile may direct the device to then report back in to the server (potentially immediately upon observing the transition) to receive a newly customized profile for the new “location” which the device occupies in configuration space. It is understood that firmware version and physical coordinates are dimensions in configuration space and that a firmware upgrade of a stationary device corresponds to a change in “location” in configuration space.

The mapping of the configuration space into these envelopes is a heuristic-based process, which may include many different considerations. Primary along these considerations is the amount of time a device is expected to remain within a given envelope. Because there is some latency, unreliability, and network load involved in reporting back into the server to get a newly customized profile, a profile should be configured to look for all critical events of interest that might be seen before initiating a change of configuration. In other words, envelope transitions are expensive, and so decomposition of the configuration space into envelopes must balance the cost of having overly broad envelopes (i.e. looking for a larger number of events at once) with the cost of transitioning between envelopes (looking for only a small number of events at a time, but more often transitioning to new envelopes and thus fetching new profiles more often). Other important considerations include the relative priority of the queries interested in each event and the available device resources.

The present invention is distinguished from conventional systems by the Event Registry store which:
Creates the ability to achieve a massive sample population of devices, while minimizing the burden of cost/logistics required to process a significant volumes of “uninteresting” data, by distribution of collection policy and logic, and centralization/automation profile generation and assignment; and
Creates the ability to execute prioritized precision parallel analytical studies of complex transient conditions, examples being, an “scheduled event” based study (Nascar, NFL, etc.), a location plus “state” centric study (roaming, etc.), or a transitory conditional study (devices gets in state x and shows symptom Y regardless of location).

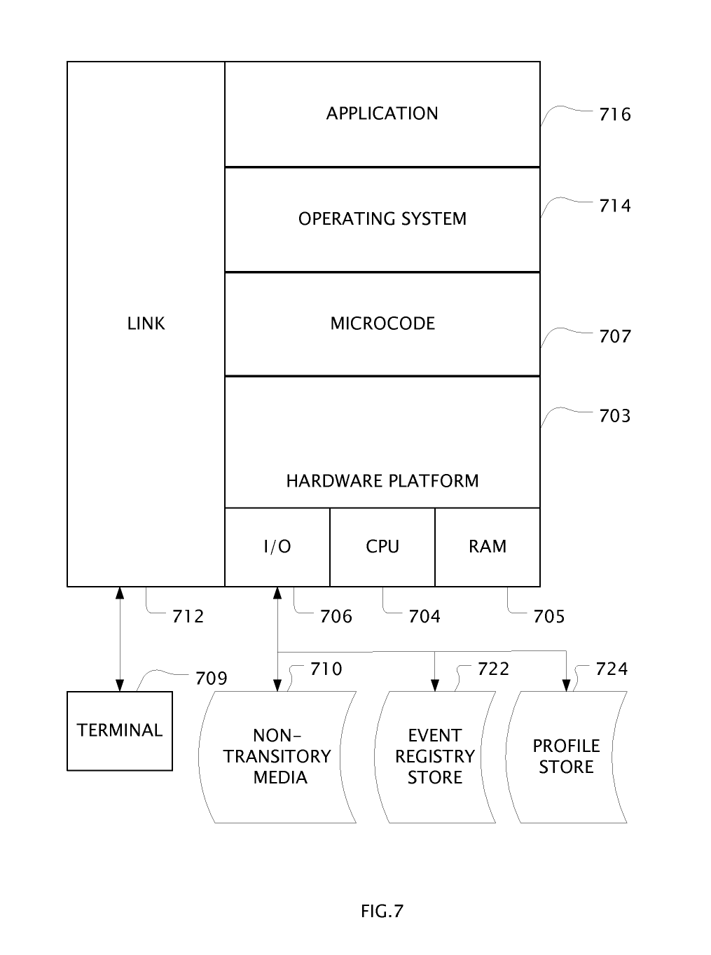

The Event Registry store contains:
medium and functional processing logic for expressions of complex, prioritized, space-time-state definitions;
criteria for dynamic generation of required profiles (can also actually generate required profiles);
central definition and management of logical analytics study criteria;
uploaded (interesting) data volumes and types; and thereby enables a processor to
determine, in realtime, individual device profile assignments, and upload policy;
   wherein a circuit can be a processor, as illustrated in FIG. 7 and described below, configured by a software program product retrieved from non-transitory computer media.

Referring to FIG. 6, dynamic tasking-masking server 200 attaches and manages an event registry store 210 which receives and stores all of the active persistent queries.

A dynamic tasking-masking server 200 receives a package of configuration-state data from a collection server at a uniform resource identifier 311. An event registry 210 identifies all studies and a profile 221 may be offered by the tasking server 200 to at least one of a plurality of agents 400 according to the configuration-state data contained in its most recently uploaded package. In an embodiment a first profile on an agent may identify a second profile appropriate to be transmitted to the agent.

The present invention in an embodiment is distinguished by dynamically generating a plurality of profiles which may be pulled by an adaptive agent from a dynamic tasking server. The present invention in an embodiment is distinguished by providing at least one profile which may be pulled by an adaptive agent from a dynamic tasking-masking server. Each adaptive agent participates in determining tasking, at least by uploading its configuration-state.

Each individual profile controls what an agent measures and records, combines a plurality of measurements and recordations into at least one package. In an embodiment a package can determine a schedule for uploading. In one embodiment, a package contains a schedule according to the tasking specification. At a first step in filtering, an agent controlled by a profile may discard data which is not useful.

Each profile has triggers to begin and end recording and at least one trigger to upload. The triggers may be a timer or a threshold for a measured value or a user behavior or a combination including a sequence. Each profile identifies which study the profile belongs to and a list of measurements. A profile may determine that an event is interesting or not interesting, which determines if and when a package is uploaded. Each profile has a destination uniform resource identifier to receive the upload of data recorded by the profile. In an embodiment, a profile may have a statistical test on combinations of measurements to determine if measurements are significant and worthy of upload.

A plurality of discriminating collection servers 311 and 312 are located at uniform resource identifiers.

### Means, Embodiments, and Structures

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium are drawn to any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

A non-limiting exemplary server is illustrated in FIG. 7. The server comprises a hardware platform 703 comprising ram 705, processor 704, input/output circuits 706, a link circuit 712. In an embodiment, the server comprises microcode 707, an operating system 714, and application code embodiment of the method steps herein disclosed 716. The server is coupled to at least one terminal 709, to non-transitory computer readable media encoded to control the processor 710, to an event registry store 722 and to a profile store 724.

### CONCLUSION

The present invention is easily distinguished from conventional systems by having a rule-based evaluation to select among a plurality of packages of measurements defined in a profile to store at an agent and transmit. The present invention is distinguished by sending packages of measurements to diverse destination uniform resource identifiers. The present invention is distinguished by packages of measurements having diverse upload schedules. The present invention is distinguished by applying a mask which enables or disables operation of selected packages or selected studies so that a plurality of packages are defined within a single profile. The method of operating a tasking-masking server is distinguished by determining if a profile on an agent should be masked or replaced based on the contents of a package uploaded from the agent, determining a mask to continue operation of the profile on the agent, and determining a replacement profile to be downloaded to the agent.

What is claimed is:

1. A method for operating a dynamic tasking-masking server comprising a circuit to receive a package of metrics recorded at an adaptive server, coupled to a circuit to search an event register for package elements, coupled to a circuit to generate a replacement profile for transmission to the agent, wherein a circuit is comprises a processor adapted by a program product and storage for data and for instructions to adapt the processor accordingly, the method comprising:
receiving a package of metrics recorded at an adaptive agent, wherein receiving comprises determining whether a profile on the adaptive agent should be replaced;
searching through an event register data structure for package elements to task the adaptive agent; and
generating a replacement multiple package profile for transmission to said adaptive agent.

2. The method of claim 1 wherein receiving a package of metrics comprises:
matching measurements received in a package of metrics with ranges stored in an event register,
identifying a plurality of studies for which an agent is qualified if it is determined that a replacement profile is appropriate because at least one measurement received in a package of metrics is within a range and the studies the agent qualifies for is different that the studies in the previous profile; and
continuing with a previous profile if it is determined that a replacement profile is not appropriate.

3. The method of claim 2 wherein searching through an event register data structure comprises:
for each one of a plurality of studies for which an agent is qualified, identifying a destination uniform resource identifier (uri),
determining which metrics and user behaviors to record to accomplish each one of a plurality of studies, and
extracting and compiling measurement intervals and upload frequencies for each one of a plurality of studies.

4. The method of claim 3 further comprising:
reviewing the relative priority of each one of a plurality of studies and
culling out at least one less important metric and behavior, if the measures are not within available resources in an agent, and
transferring control to profile generation when the measures are within available resources.

5. The method of claim 1 wherein generating a replacement multiple package profile comprises:
configuring a profile to adapt an agent to transmit at least one package according to a first schedule and at least one package according to at least one second schedule.

6. The method of claim 1 wherein generating a replacement multiple package profile comprises:
configuring a profile to adapt an agent to transmit a first package to at least one first uniform resource identifier and at least one second package to at least one second uniform resource identifier.

7. The method of claim 1 wherein generating a replacement multiple package profile comprises:
configuring a profile to adapt an agent to record parameter-value pairs of user behavior and device performance according to a study selected from an event register data structure.

8. The method of claim 1 wherein generating a replacement multiple package profile comprises:
transmitting a first profile to a first adaptive agent and storing the first profile into a profile cache, and
determining if a package from a first adaptive agent is substantially the same as a package from at least one second adaptive agent and sending the first profile from profile cache to the at least one second adaptive agent.

9. The method of claim 1 wherein generating a replacement multiple package profile comprises:
configuring a profile to adapt an agent to operate on selected parameter-value pairs which result in a first package and trigger a rule-based evaluation of the parameter-value pairs of said first package which configures the profile to further select parameter-value pairs which result in at least one of a plurality of second packages.

10. The method of claim 8 wherein determining whether a profile on the adaptive agent should be replaced comprises:
checking if the profile is older that the latest version of the event register;
matching measurements received in a package of metrics with a profile stored in profile cache, and
generating a replacement profile only if there are new studies in the event register not considered when the profile on the adaptive agent was generated and if a substantially same replacement profile is not already in profile cache.

11. An apparatus comprising
a circuit to receive a package of metrics recorded at an adaptive agent, coupled to
a circuit to search an event register for package elements, coupled to
a circuit to generate a replacement multiple package profile for transmission to the agent, wherein a circuit comprises a processor adapted by a program product and storage for data and for instructions to adapt the processor accordingly.

12. The apparatus of claim 11 wherein the replacement multiple package profile comprises
at least one first package definition with a first uniform resource identifier (uri) destination and
at least one second package definition with a second uri destination wherein the first uri is not equal to the second uri.

13. The apparatus of claim 11 wherein the replacement multiple package profile comprises
at least a first package definition comprising a first set of parameter-value pairs and
at least one second package definition comprising a second set of parameter-value pairs wherein the first set of .parameter-value pairs of the first package is not equal to the parameter-value pairs of the second set.

14. The apparatus of claim 11 wherein the replacement multiple package profile comprises
at least one first package definition comprising a first upload schedule and
at least one second package definition comprising a second upload schedule wherein the first upload schedule is different from the second upload schedule.

15. The apparatus of claim 11 wherein the replacement multiple package profile comprises
at least one first package definition specifying parameter-value pairs and
at least one second package definition specifying parameter-value pairs and a trigger conditioned by a rule-based evaluation of the parameter-value pairs of said first package which activates recording the parameter-value pairs of the at least one second package.

16. The apparatus of claim 11 wherein the replacement multiple package profile comprises
at least one first package definition specifying parameter-value pairs and
at least one second package definition and a trigger conditioned by a rule-based evaluation of the parameter-value pairs of said first package which configures said at least one second package definition, wherein the rule-based evaluation of the parameter-value pairs of said first package configures said at least one second package upload schedule definition.

17. An apparatus for dynamically tasking-masking an adaptive agent comprising
a circuit to receive a package of data recorded at an adaptive agent,
a circuit to match data values in a package with at least one study profile stored in an event registration data structure,
a circuit to determine that a replacement profile is appropriate for said adaptive agent, and
a circuit to download said replacement profile to said adaptive agent.

18. The apparatus of claim 17 wherein said study profile stored in an event registration data structure is at least location and time reported by an adaptive agent.

19. The apparatus of claim 17 wherein said study profile stored in an event registration data structure is at least error codes and device performance metrics recorded by an adaptive agent.

20. The apparatus of claim 17 wherein said study profile stored in an event registration data structure is at least user behaviors and applications recorded by an adaptive agent.
